(19) United States
(12) Patent Application Publication
(10) Pub. No.: US 2023/0231170 A1
(43) Pub. Date: Jul. 20, 2023

(54) METHOD FOR PREPARING VANADIUM ELECTROLYTE FOR ALL-VANADIUM REDOX FLOW BATTERY

(71) Applicant: VRB ENERGY OPERATIONS (BEIJING) CO. LTD., Beijing (CN)

(72) Inventors: Mianyan HUANG, Beijing (CN); Qiming GE, Beijing (CN); Jia LIU, Beijing (CN)

(21) Appl. No.: 18/157,013

(22) Filed: Jan. 19, 2023

(30) Foreign Application Priority Data
Jan. 20, 2022 (CN) 202210069306.7

(51) Int. Cl. H01M 8/18

(52) U.S. Cl. CPC H01M 8/18; H01M 2300/0002

(57) ABSTRACT

The application relates to battery materials, and particularly discloses a method for preparing vanadium electrolyte for an all-vanadium redox flow battery. An example method includes: heating high-purity vanadium pentoxide, and reducing the high-purity vanadium pentoxide by using a reducing gas to obtain a low-valence vanadium oxide; mixing low-valence vanadium oxide with an activating agent, and heating and activating to obtain vanadium-containing paste electrolyte; and adding water to dissolve the vanadium-containing paste electrolyte to obtain the vanadium electrolyte with the average valence of vanadium between positive three and positive four. Compared with a finished product vanadium electrolyte, the vanadium-containing paste electrolyte is small in size, and the sulfuric acid is solidified, so that the corrosion of the sulfuric acid to a container can be reduced, the cost for transporting the vanadium-containing paste electrolyte is lower than the cost for directly transporting the vanadium electrolyte, and the vanadium electrolyte is promoted.

### RELATED APPLICATIONS

This application claims priority to and the benefit of Chinese Patent Application No. 202210069306.7, filed on Jan. 20, 2022, the disclosure of which is expressly incorporated herein by reference in its entirety.

### TECHNICAL FIELD

The application relates to the technical field of battery materials, in particular to a method for preparing vanadium electrolyte for an all-vanadium redox flow battery.

### BACKGROUND

The all-vanadium redox flow battery is a novel electrochemical energy storage system, and compared with the traditional battery, the all-vanadium redox flow battery has the characteristics of capability of quick and large-capacity charging and discharging, low self-discharge rate, simple battery structure and the like. The vanadium electrolyte is the core of energy storage and energy conversion of the vanadium battery, and is usually sulfuric acid containing VO2+/VO2+ and V2+/V3+ redox potentials. In practical production and application, in order to facilitate popularization of the vanadium redox battery, not only is a high-concentration electrolyte required to achieve high specific energy of the vanadium redox battery, but also the electrolyte is required to have high stability.

In the related technology, most of high-purity vanadium pentoxide or vanadium oxide with vanadium pentoxide as a main component is used as a raw material, a part of pentavalent vanadium is reduced into trivalent vanadium through electrolysis or reduction by adding a reducing agent, and then a product obtained is dissolved and reduced by using sulfuric acid to obtain vanadium electrolyte with the water content of 70-80%.

In view of the above-mentioned related technologies, the inventor believes that, although a vanadium electrolyte is obtained in the related technologies, the obtained vanadium electrolyte contains a large amount of sulfuric acid components and has strong fluidity, so that the vanadium electrolyte is greatly limited in transportation, and needs to be transported by using a special container, which greatly increases the transportation cost of the vanadium electrolyte and is not beneficial to popularization of the vanadium electrolyte.

### SUMMARY

In order to improve the defect, the application provides a method for preparing a vanadium electrolyte for an all-vanadium redox flow battery.

The application provides a method for preparing vanadium electrolyte for an all-vanadium redox flow battery, which adopts the following technical scheme:

a method for preparing a vanadium electrolyte for an all-vanadium redox flow battery comprises the following steps:

(1) heating high-purity vanadium pentoxide, and reducing the high-purity vanadium pentoxide by using a reducing gas to obtain a low-valence vanadium oxide;

(2) mixing low-valence vanadium oxide with an activating agent, and heating and activating to obtain vanadium-containing paste electrolyte;

(3) and adding water to dissolve the vanadium-containing paste electrolyte to obtain the vanadium electrolyte with the average valence of vanadium between positive three and positive four.

By adopting the technical scheme, according to the method, a part of pentavalent vanadium in high-purity vanadium pentoxide is reduced into trivalent vanadium by using a reducing gas to obtain a low-valent vanadium oxide, the low-valent vanadium oxide is activated by using sulfuric acid under a heating condition to obtain a vanadium-containing paste electrolyte, and the vanadium-containing paste electrolyte can form a vanadium electrolyte after being dissolved by adding water. In the practical application process, a manufacturer firstly carries out the operation of the step (1) and the step (2) to prepare the vanadium-containing paste electrolyte, and then transports the vanadium-containing paste electrolyte to a user. And (4) the user executes the step (3), and the vanadium-containing paste electrolyte is dissolved in water to obtain the vanadium electrolyte.

When the vanadium-containing paste electrolyte is transported, the vanadium-containing paste electrolyte is a paste solid, so that the vanadium-containing paste electrolyte has poor fluidity, the sulfuric acid is solidified, and the possibility of corrosion of the sulfuric acid to a container in the carrying process is reduced; the density of the vanadium-containing paste electrolyte is greater than that of the vanadium electrolyte, so that the storage space occupied by the vanadium-containing paste electrolyte is smaller than that occupied by the vanadium electrolyte. In summary, the cost of transporting vanadium-containing paste electrolyte is lower than the cost of directly transporting vanadium electrolyte, both in view of the degree of corrosion to the container and the storage space occupied during transportation. The vanadium-containing paste electrolyte is dissolved in water to prepare the vanadium electrolyte, so that the operation is simple, the normal use of the vanadium electrolyte by a user is not influenced, and the popularization of the vanadium electrolyte is facilitated.

Preferably, in the step (1) of preparing the vanadium electrolyte, the temperature for heating the high-purity vanadium pentoxide is 400-800° C.

By adopting the technical scheme, when the temperature for heating the high-purity vanadium pentoxide is lower than 400° C., the vanadium pentoxide has poor reactivity, and the reduction of the vanadium pentoxide is easily hindered. When the temperature is higher than 800° C., the energy consumption in the reduction process is high, the cost for producing the vanadium electrolyte is increased, and the vanadium electrolyte is not beneficial to popularization.

Preferably, the high-purity vanadium pentoxide is heated for 1-5 h under the temperature condition of 400-800° C.

By adopting the technical scheme, when the time for heating the high-purity vanadium pentoxide is less than 1 h, the high-purity vanadium pentoxide participating in the reduction reaction is less, so that the reduction of the pentavalent vanadium is incomplete, and the using effect of the vanadium electrolyte is influenced. When the time of the heating treatment exceeds 5 hours, the period for producing the vanadium electrolyte is long, and the vanadium electrolyte is not beneficial to popularization.

Preferably, in the step (1) of preparing the vanadium electrolyte, the reducing gas is any one of hydrogen, carbon monoxide and sulfur dioxide in the step (1) of preparing the vanadium electrolyte.

Through adopting above-mentioned technical scheme, hydrogen, carbon monoxide, sulfur dioxide are reducing gas, wherein, can generate sulfur trioxide after sulfur dioxide and vanadic anhydride reaction, sulfur trioxide can react with water and generate sulfuric acid at the activation in-process to realize practicing thrift the effect of sulfuric acid, help reducing the manufacturing cost of vanadium electrolyte.

Preferably, the flow rate of the reducing gas is 100-500 mL/min, and the time for reducing the high-purity vanadium pentoxide by the reducing gas is 1-5 hours (h).

By adopting the technical scheme, when the flow rate of the reducing gas is lower than 100 mL/min, the contact between the reducing gas and the high-purity vanadium pentoxide is insufficient, so that the effect of reducing the pentavalent vanadium is poor. When the flow rate of the reducing gas is too high, the reducing gas is consumed too fast, the cost for producing the vanadium electrolyte is high, and the vanadium electrolyte is not beneficial to popularization.

Preferably, in the step (2) of preparing the vanadium electrolyte, the temperature for heating and activating is 120-400° C.

By adopting the technical scheme, when the activation temperature is less than 120° C., the low-valence vanadium oxide cannot be completely generated into the paste vanadium-containing electrolyte, so that the vanadium content in the vanadium electrolyte is low, and the unreacted low-valence vanadium oxide can form precipitates in the vanadium electrolyte to influence the quality of the vanadium electrolyte.

Preferably, in the step (2) of preparing the vanadium electrolyte, the time of heating activation is 1-5 h.

By adopting the technical scheme, when the heating and activating time is less than 1 h, the low-valence vanadium oxide cannot completely generate the paste vanadium-containing electrolyte, so that the vanadium content in the vanadium electrolyte is low, and when the heating and activating time is too long, the energy consumption in the production process is too high, the cost for generating the vanadium electrolyte is increased, and the popularization of the vanadium electrolyte is not facilitated.

Preferably, the activating agent is sulfuric acid, and the weight ratio of the sulfuric acid to the low-valence vanadium oxide is (1-5):1.

By adopting the technical scheme, when the weight ratio of the sulfuric acid to the low-valence vanadium oxide is lower than 1, the low-valence vanadium oxide cannot completely generate the paste vanadium-containing electrolyte, so that the vanadium content in the vanadium electrolyte is low, the conductivity of the vanadium electrolyte is poor, and the popularization of the vanadium electrolyte is influenced.

Preferably, in the vanadium-containing paste electrolyte, the weight percentage of vanadium is 13-30%, the weight percentage of sulfuric acid is 60-80%, in the step (3) of preparing the vanadium electrolyte, the dissolving temperature is 20-90° C., the time required for dissolving is 1-3 h, and the weight ratio of water to the vanadium-containing paste electrolyte is (3-7):1.

By adopting the technical scheme, the vanadium-containing paste electrolyte can be dissolved in water at room temperature to form vanadium electrolyte, when the temperature is higher than 20° C., the dissolution rate is accelerated, the dissolution time is shortened, and the efficiency of generating the vanadium electrolyte is improved. The vanadium-containing paste electrolyte is used for solidifying sulfuric acid which accounts for 60-80% of the weight of the vanadium-containing paste electrolyte, corrosion of the sulfuric acid to a container is reduced, high sulfuric acid carrying rate is achieved as optimization, and the performance of the vanadium electrolyte meets the performance requirements of GB/T37204-2018.

By adopting the technical scheme, the existing vanadium electrolyte production process is improved, and the obtained vanadium electrolyte meets the existing standards related to vanadium electrolytes.

In summary, the present application has the following beneficial effects:

1. According to the method, high-purity vanadium pentoxide is used as a raw material, the vanadium-containing paste electrolyte is obtained through reduction and activation, the vanadium-containing paste electrolyte can be dissolved by adding water to obtain the vanadium electrolyte, and compared with the finished vanadium electrolyte, the vanadium-containing paste electrolyte is small in size, has a curing effect on sulfuric acid, can reduce corrosion to a container, enables the cost for transporting the vanadium-containing paste electrolyte to be lower than the cost for directly transporting the vanadium electrolyte, and is beneficial to popularization of the vanadium electrolyte.

2. The temperature for activating the low-valence vanadium oxide is preferably 120-400° C., so that the possibility of incomplete conversion of the low-valence vanadium oxide is reduced, the vanadium content in the vanadium electrolyte is increased, and the quality of the vanadium electrolyte is improved.

Additional aspects and advantages will be apparent from the following detailed description of preferred embodiments, which proceeds with reference to the accompanying drawings.

### BRIEF DESCRIPTION OF THE DRAWINGS

FIG. 1 is a composition data table of high-purity vanadium pentoxide in accordance with examples described herein.

FIG. 2 is a table of average valence state of vanadium in accordance with examples described herein.

FIG. 3 is a table of total vanadium concentration of vanadium electrolyte in accordance with examples described herein.

FIG. 4 is a table of weight percentage of vanadium and weight percentage of sulfuric acid in a vanadium-containing paste electrolyte in accordance with examples described herein.

### DETAILED DESCRIPTION

The present application will be described in further detail with reference to examples.

### EXAMPLES

### Examples 1 to 5

The following description will be given by taking example 1 as an example.

### Example 1

The vanadium electrolyte in example 1 was prepared according to the following procedure:

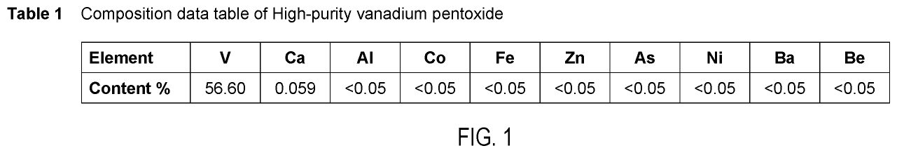

(1) taking 10 g of high-purity vanadium pentoxide, putting the high-purity vanadium pentoxide into a crucible, putting the crucible into a heating device, heating for 4 hours at 600° C., introducing hydrogen into the crucible at a rate of 250 mL/min while heating, and obtaining calcine after heating, wherein the calcine is low-valence vanadium oxide; the components of the metal elements in the high-purity vanadium pentoxide are shown in Table 1 of FIG. 1;

(2) taking 4 g of low-valence vanadium oxide, putting the low-valence vanadium oxide into a glass vessel, adding 12 g of concentrated sulfuric acid into the glass vessel, putting the glass vessel into a heating device, heating the glass vessel at 300° C. for 2 hours, and generating yellow-green solid matters after the reaction is finished, wherein the yellow-green solid matters are vanadium-containing paste electrolyte; in the step, the mass fraction of the concentrated sulfuric acid is 98%;

(3) mixing the vanadium-containing paste electrolyte with water at 60° C. according to the weight ratio of 1:5, and keeping the temperature for 2 h to obtain the vanadium electrolyte.

### Example 2

The difference between this example and example 1 is that the heating temperature in step (1) is 650° C., the heating time is 2 h, and the rate of introducing hydrogen is 200 mL/min.

### Example 3

The difference between this example and example 1 is that the heating time in step (1) is 1 h and the rate of hydrogen gas introduction is 200 mL/min.

### Example 4

This example is different from example 2 in that the amount of sulfuric acid used in step (2) was 12.8 g.

### Example 5

The difference between the embodiment and the embodiment 1 is that the dosage of the vanadium oxide in the step (2) is 8 g, and the dosage of the concentrated sulfuric acid is 5 g.

### Example 6

The present example is different from example 4 in that the heating time in step (2) is 30 min.

### Example 7

This example is different from example 3 in that the heating temperature in step (2) was 80° C.

### Example 8

This example differs from example 1 in that hydrogen is replaced by carbon monoxide.

### Example 9

This example differs from example 1 in that hydrogen was replaced with sulfur dioxide.

### Comparative Example

### Comparative Example 1

This comparative example is different from example 1 in that the reduction temperature in step (1) is 200° C.

### Comparative Example 2

This comparative example is different from example 1 in that the rate of hydrogen gas introduction in step (1) was 60 mL/min.

### Comparative Example 3

This comparative example is different from example 1 in that the heating time in step (1) was 30 min.

Performance Detection Test Method

The detection standard referred to in performance detection is GB/T37204 and 2018 electrolyte for all-vanadium redox flow batteries, and the analysis equipment used in the detection process is Agilent 725ICP-OES inductively coupled plasma emission spectrometer.

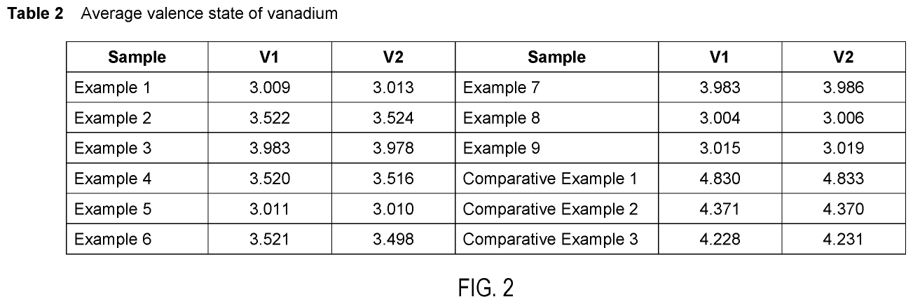

The vanadium suboxides and the vanadium electrolytes obtained in the examples and comparative examples were collected, and the average valence of vanadium in the vanadium suboxide (V1) and the average valence of vanadium in the vanadium electrolyte (V2) were evaluated by titration, and the results are shown in Table 2 in FIG. 2.

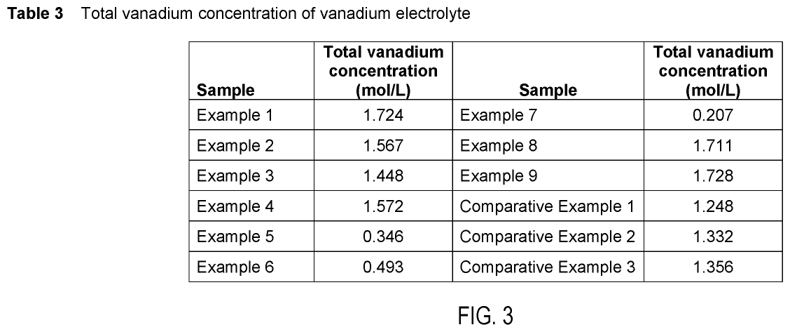

The vanadium electrolytes in the examples and the comparative examples were collected, and the total vanadium concentration in the vanadium electrolyte was measured, and the measurement results are shown in Table 3 in FIG. 3.

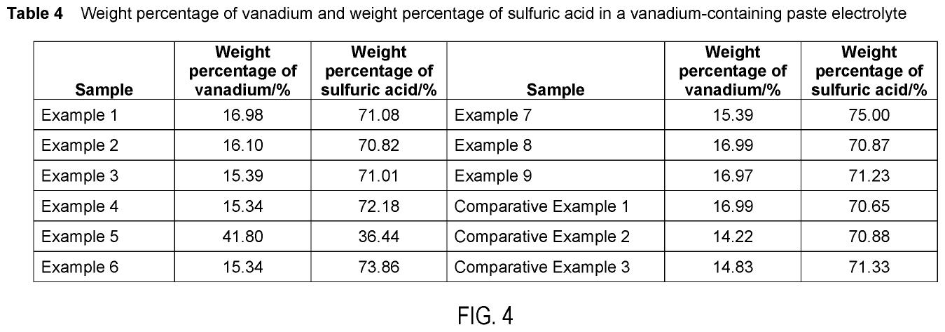

The vanadium-containing paste electrolytes of the examples and comparative examples were collected, and then the weight percentage of sulfuric acid and the weight percentage of vanadium in the vanadium-containing paste electrolytes were measured, and the results are shown in Table 4 in FIG. 4.

It can be seen from the combination of example 1 and comparative example 1 and Table 2 that both V1 and V2 measured in comparative example 1 are higher than those measured in example 1 and both measured values are 4 or more, while both V1 and V2 measured in example 1 are between 3 and 4, because the reaction activity of vanadium pentoxide is poor and the reduction of vanadium pentoxide is hindered when the temperature for reducing high-purity vanadium pentoxide is lower than 400° C., while the reduction temperature in example 1 is 400° C. or more, so that the reduction of vanadium pentoxide is more complete in example 1.

It can be seen from the combination of example 1 and comparative example 2 and Table 2 that comparative example 2 has higher V1 and V2 than example 1 and has a measurement value of 4 or more, and example 1 has V1 and V2 of 3 to 4, because when the flow rate of the reducing gas is less than 100 mL/min, the contact between the reducing gas and the high-purity vanadium pentoxide is insufficient, resulting in deterioration of the effect of reducing the vanadium pentoxide. The flow rate of the reducing gas in example 1 is higher than 100 mL/min, so that the reduction of pentavalent vanadium in example 1 is more thorough.

As can be seen by combining example 1 and comparative example 3 with Table 2, both V1 and V2 measured in comparative example 3 were higher than those measured in example 1 and both measured values were 4 or more, while both V1 and V2 measured in example 1 were between 3 and 4, because when the heating time during the reduction was less than 1 hour, the high-purity vanadium pentoxide that participated in the reduction reaction was less, resulting in incomplete reduction of the pentavalent vanadium. And the heating time in the reduction process of the embodiment 1 is more than 1 h, so that the embodiment 1 can more completely reduce the pentavalent vanadium.

It can be seen from the combination of examples 1-4 and Table 2 that examples 1-3 sequentially control the average valence of vanadium around 3.0, 3.5 and 4.0, while example 4 adjusts the average valence of vanadium to be closer to 3.5 on the basis of example 2, thereby facilitating the standardized production of vanadium electrolyte.

Combining example 1, example 5 and Table 3, it can be seen that the total vanadium concentration measured in example 1 is higher than in example 5, since sulfuric acid is sufficient to react completely with the vanadium suboxides at a ratio of sulfuric acid to vanadium suboxides of between 1 and 5 by weight. The weight ratio of the sulfuric acid to the vanadium suboxide in example 1 is (1-5):1, and thus the conversion of the lower vanadium oxide in example 1 is more complete.

It can be seen from the combination of example 4, example 6 and Table 3 that the total vanadium concentration measured in example 4 is higher than that in example 6 because the reactivity of the vanadium suboxide is affected when the activation temperature is lower than 120° C., while the temperature for activating the vanadium suboxide in example 4 is higher than 120° C., so that the conversion of the vanadium suboxide in example 4 is more complete. The activation temperature in example 6 is below 120° C., so the conversion of the vanadium suboxides of example 6 is not complete.

It can be seen from the combination of example 3, example 7 and Table 3 that the total vanadium concentration measured in example 3 is higher than that in example 7 because the vanadium suboxides have not been completely converted into vanadium-containing paste electrolyte when the activation time is less than 1 hour, whereas the time for activating the vanadium suboxides in example 3 is more than 1 hour, so that the conversion of the vanadium suboxides in example 3 is more complete. The activation time in example 7 was less than 1 h, resulting in incomplete conversion of the vanadium suboxide of example 6.

It can be seen from the combination of examples 1 and 8-9 and Tables 2 and 3 that when any one of hydrogen, carbon monoxide and sulfur dioxide is selected as the reducing gas, the properties of the produced vanadium electrolyte are close to each other, so that manufacturers can select the vanadium electrolyte by comprehensively considering the cost difference of the three.

In combination with examples 1-9, comparative examples 1-3 and Table 4, it can be seen that, except for the large deviation of the values in example 5 due to the adjustment of the material amount, the weight percentage of vanadium in each example and comparative example is in the range of 13-30%, the weight percentage of sulfuric acid is in the range of 60-80%, and the extreme differences between the two sets of data are single digits, which indicates that the method of the present application is not likely to cause the fluctuation of the vanadium electrolyte composition when the material ratio is fixed.

The present embodiment is only for explaining the present application, and it is not limited to the present application, and those skilled in the art can make modifications of the present embodiment without inventive contribution as needed after reading the present specification, but all of them are protected by patent law within the scope of the claims of the present application.

It will be obvious to those having skill in the art that many changes may be made to the details of the above-described embodiments without departing from the underlying principles of the invention. The scope of the present invention should, therefore, be determined only by the following claims.

What is claimed is:

1. A method for preparing a vanadium electrolyte for an all-vanadium redox flow battery, the method comprising:
heating high-purity vanadium pentoxide, and reducing the high-purity vanadium pentoxide using a reducing gas to obtain a low-valence vanadium oxide;
mixing the low-valence vanadium oxide with an activating agent, and then heating and activating to obtain a vanadium-containing paste electrolyte; and
adding water to dissolve the vanadium-containing paste electrolyte to obtain a vanadium electrolyte with an average valence of vanadium between positive three and positive four.

2. The method for preparing the vanadium electrolyte for the all-vanadium redox flow battery according to claim 1, wherein the temperature of heating the high-purity vanadium pentoxide is 400 to 800° C. in heating the high-purity vanadium pentoxide.

3. The method for preparing the vanadium electrolyte for the all-vanadium redox flow battery according to claim 2, wherein the time for heating the high-purity vanadium pentoxide under a temperature condition of 400 to 800° C. is 1 to 5 hours (h).

4. The method for preparing the vanadium electrolyte for the all-vanadium redox flow battery according to claim 1, wherein the reducing gas is any one of hydrogen, carbon monoxide, or sulfur dioxide in heating the high-purity vanadium pentoxide.

5. The method for preparing the vanadium electrolyte for the all-vanadium redox flow battery according to claim 4, wherein the flow rate of the reducing gas is 100 to 500 mL/min, and a duration for reducing the high-purity vanadium pentoxide by the reducing gas is 1 to 5 h.

6. The method for preparing the vanadium electrolyte for the all-vanadium redox flow battery according to claim 1, wherein the temperature of heating and activating is 120 to 400° C. in mixing the low-valence vanadium oxide with the activating agent.

7. The method for preparing the vanadium electrolyte for the all-vanadium redox flow battery according to claim 1, wherein the time of heating and activating is 1 to 5 h in mixing the low-valence vanadium oxide with an activating agent.

8. The method for preparing the vanadium electrolyte for the all-vanadium redox flow battery according to claim 1, the method further comprising selecting sulfuric acid the activating agent, wherein a weight ratio of the sulfuric acid and the low-valence vanadium oxide is (1-5):1.

9. The method for preparing the vanadium electrolyte for the all-vanadium redox flow battery according to claim 1, wherein the vanadium-containing paste electrolyte, a weight percentage of vanadium in the vanadium-containing paste electrolyte is 13% to 30%, and wherein a weight percentage of sulfuric acid is 60% to 80%, and wherein the dissolution temperature is 20 to 90° C., the time for dissolution is 1 to 3 h, and a weight ratio of water to the vanadium-containing paste electrolyte is (3-7):1 while adding the water.

10. The method for preparing the vanadium electrolyte for the all-vanadium redox flow battery according to claim 1, wherein the performance of the vanadium electrolyte meets performance requirements of GB/T37204-2018.
